(19) United States
(12) Patent Application Publication
(10) Pub. No.: US 2024/0037177 A1
(43) Pub. Date: Feb. 1, 2024

(54) OPTIMIZATION DEVICE, OPTIMIZATION METHOD, AND RECORDING MEDIUM

(71) Applicant: NEC Corporation, Minato-ku, Tokyo (JP)

(72) Inventor: Shinji Ito, Tokyo (JP)

(73) Assignee: NEC Corporation, Minato-ku, Tokyo (JP)

(21) Appl. No.: 18/022,475

(22) PCT Filed: Sep. 29, 2020
(86) PCT No.: PCT/JP2020/036921

§ 371 Date: Feb. 21, 2023

(51) Int. Cl. G06F 17/11

(52) U.S. Cl. CPC G06F 17/11

(57) ABSTRACT

In an optimization device, an acquisition means acquires a reward obtained by executing a certain policy. An updating means updates a probability distribution of the policy based on the obtained reward. Here, the updating means uses a weighted sum of the probability distributions updated in a past as a constraint. A determination means determines the policy to be executed, based on the updated probability distributions.

### TECHNICAL FIELD

This disclosure relates to optimization techniques for decision making.

### BACKGROUND ART

There are known techniques to perform optimization, such as optimization of product prices, which select and execute an appropriate policy from among candidates of policy and sequentially optimize the policy based on the obtained reward. Patent Document 1 discloses a technique for performing appropriate decision making against constraints.

### PRECEDING TECHNICAL REFERENCES

### Patent Document

Patent Document 1: International Publication WO2020/012589

### SUMMARY

### Problem to be Solved

The technique described in Patent Document 1 supposes that an objective function is a probability distribution (stochastic setting). However, in a real-world environment, there are cases where it is not possible to suppose that the objective function is a specific probability distribution (adversarial setting). For this reason, it is difficult to determine which of the above problem settings the objective function fits in a realistic decision making. Also, various algorithms have been proposed in the adversarial setting. However, in order to select an appropriate algorithm, it is necessary to appropriately grasp the structure of the “environment” (e.g., whether the variation in the obtained reward is large or not), and it requires human judgment and knowledge.

An object of the present disclosure is to provide an optimization method capable of determining an optimum policy without depending on the setting of the objective function or the structure of the “environment”.

### Means for Solving the Problem

According to an example aspect of the present disclosure, there is provided an optimization device comprising:
an acquisition means configured to acquire a reward obtained by executing a certain policy;
an updating means configured to update a probability distribution of the policy based on the obtained reward; and
a determination means configured to determine the policy to be executed, based on the updated probability distribution,
wherein the updating means uses a weighted sum of the probability distributions updated in a past as a constraint.

According to another example aspect of the present disclosure, there is provided an optimization method comprising:
acquiring a reward obtained by executing a certain policy;
updating a probability distribution of the policy based on the obtained reward; and
determining the policy to be executed, based on the updated probability distribution,
wherein the probability distribution is updated by using a weighted sum of the probability distributions updated in a past as a constraint.

According to still another example aspect of the present disclosure, there is provided a recording medium recording a program, the program causing a computer to execute:
acquiring a reward obtained by executing a certain policy;
updating a probability distribution of the policy based on the obtained reward; and
determining the policy to be executed, based on the updated probability distribution,
wherein the probability distribution is updated by using a weighted sum of the probability distributions updated in a past as a constraint.

### BRIEF DESCRIPTION OF THE DRAWINGS

FIG. 1 is a block diagram showing a hardware configuration of an optimization device.

FIG. 2 is a block diagram showing a functional configuration of the optimization device.

FIG. 3 is a flowchart of optimization processing according to a first example embodiment.

FIG. 4 is a flowchart of optimization processing according to a second example embodiment.

FIG. 5 is a block diagram showing a functional configuration of the optimization device according to a third example embodiment.

FIG. 6 is a flowchart of prediction processing by the optimization device of the third example embodiment.

FIG. 7 schematically shows a basic example of the optimization processing of the present disclosure.

FIG. 8 shows an example of applying the optimization method of the example embodiments to a field of retail.

FIG. 9 shows an example of applying the optimization method of the example embodiments to a field of investment.

FIG. 10 shows an example of applying the optimization method of the example embodiments to a medical field.

FIG. 11 shows an example of applying the optimization method of the example embodiment to marketing.

FIG. 12 shows an example of applying the optimization method of the example embodiments to prediction of power demand.

FIG. 13 shows an example of applying the optimization method of the example embodiments to a field of communication.

### EXAMPLE EMBODIMENTS

Preferred example embodiments of the present disclosure will be described with reference to the accompanying drawings.

### First Example Embodiment

[Premise Explanation]

(Bandit Optimization)

Bandit optimization is a method of sequential decision making using limited information. In the bandit optimization, the player is given a set A of policies (actions), and sequentially selects a policy iₜ to observe loss lₜ(iₜ) at every time step t. The goal of the player is to minimize the regret R_{T} shown below.

$${R}_{T} = {\sum }_{t = 1}^{T} {ℓ}_{t} ( {i}_{t} ) = {min}_{{i}^{*} ∈ 𝒜} {\sum }_{t = 1}^{T} {ℓ}_{t} ( {i}^{*} ) \qquad ( 1 )$$

There are mainly two different approaches in the existing bandit optimization. The first approach relates to the stochastic environment. In this environment, the loss lₜ follows an unknown probability distribution for all the time steps t. That is, the environment is time-invariant. The second approach relates to an adversarial or non-stochastic environment. In this environment, there is no model for the loss lₜ and the loss lₜ can be adversarial against the player.

(Multi-Armed Bandit Problem)

In a multi-armed bandit problem, a set of policies is a finite set [K] of the size K. At each time step t, the player selects the policy iₜ∈[K] and observes the loss lₜᵢₜ. The loss vector lₜ=(lₜ₁, lₜ₂, . . . , lₜₖ)^{T}∈[0,1]^{K} can be selected adversarially by the environment. The goal of the player is to minimize the following regret.

$${R}_{T} = {\sum }_{t = 1}^{T} {ℓ}_{{ti}_{t}} = {min}_{{i}^{*} ∈ [ K ]} {\sum }_{t = 1}^{T} {ℓ}_{{ti}^{*}} \qquad ( 2 )$$

In this problem setting, lₜᵢ corresponds to the loss by selecting the policy i in the time step t. When we consider maximizing the reward rather than minimizing the loss, we associate lₜᵢ as “lₜᵢ=(−1)×reward”. l_{ti*} is the loss by the best policy. The regret shows how good the player's policy is, in comparison with the best policy that will become consequently clear.

In the multi-armed bandit problem, a stochastic model or an adversarial model is used. The stochastic model is a model suitable for a stationary environment, and it is assumed that the loss lₜ obtained by the policy follows an unknown stationary probability distribution. On the other hand, the adversarial model is a model suitable for the non-stationary environment, i.e., the environment in which the loss lₜ obtained by the policy does not follow the probability distribution, and it is assumed that the loss lₜ can be adversarial against the player.

Examples of the adversarial model include a worst-case evaluation model, a First-order evaluation model, a Variance-dependent evaluation model, and a Path-length dependent evaluation model. The worst-case evaluation model can guarantee the performance, i.e., can keep the regret within a predetermined range, if the real environment is the worst case (the worst-case environment for the algorithm). In the First-order evaluation model, the performance is expected to be improved if there is a policy to reduce the cumulative loss. In the Variance-dependent evaluation model, the improvement of the performance can be expected when the dispersion of the loss is small. In the Path-length dependent evaluation model, the improvement of the performance can be expected when the time variation of the loss is small.

As mentioned above, for the multi-armed bandit problem, some models are applicable depending on whether the real environment is a stationary environment or a non-stationary environment. Therefore, in order to achieve optimum performance, it is necessary to select an appropriate algorithm according to the environment in the real world. In reality, however, it is difficult to select an appropriate algorithm by knowing the structure of the environment (stationary/non-stationary, magnitude of variation) in advance.

Therefore, in the present example embodiment, the need of selecting an algorithm according to the structure of the environment is eliminated, and a single algorithm is used to obtain the same result as the case where an appropriate algorithm is selected from a plurality of algorithms.

[Hardware Configuration]

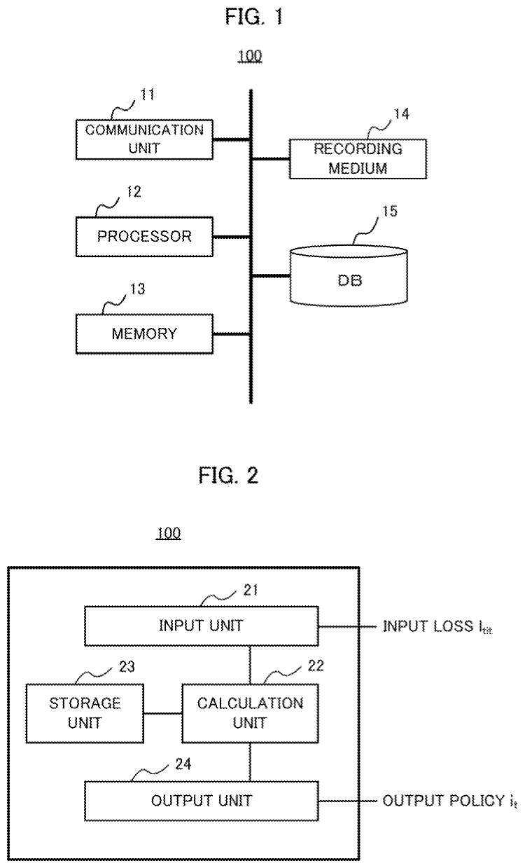

FIG. 1 is a block diagram illustrating a hardware configuration of an optimization device 100. As illustrated, the optimization device 100 includes a communication unit 11, a processor 12, a memory 13, a recording medium 14, a data base (DB) 15.

The communication unit 11 inputs and outputs data to and from an external device. Specifically, the communication unit 11 outputs the policy selected by the optimization device 100 and acquires a loss (reward) caused by the policy.

The processor 12 is a computer such as a CPU (Central Processing Unit) and controls the entire optimization device 100 by executing a program prepared in advance. The processor 12 may use one of CPU, GPU (Graphics Processing Unit), FPGA (Field-Programmable Gate Array), DSP (Demand-Side Platform) and ASIC (Application Specific Integrated Circuit), or a plurality of them in parallel. Specifically, the processor 12 executes an optimization processing described later.

The memory 13 may include a ROM (Read Only Memory) and a RAM (Random Access Memory). The memory 13 is also used as a working memory during various processing operations by the processor 12.

The recording medium 14 is a non-volatile and non-transitory recording medium such as a disk-like recording medium, a semiconductor memory, or the like, and is configured to be detachable from the optimization device 100. The recording medium 14 records various programs executed by the processor 12. When the optimization device 100 executes the optimization processing, the program recorded in the recording medium 14 is loaded into the memory 13 and executed by the processor 12.

The DB 15 stores the input data inputted through the communication unit 11 and the data generated during the processing by the optimization device 100. The optimization device 100 may be provided with a display unit such as a liquid crystal display device, and an input unit for an administrator or the like to perform instruction or input, if necessary.

[Functional Configuration]

FIG. 2 is a block diagram showing a functional configuration of the optimization device 100. In terms of functions, the optimization device 100 includes an input unit 21, a calculation unit 22, a storage unit 23, and an output unit 24. The input unit 21 acquires the loss obtained as a result of executing a certain policy, and outputs the loss to the calculation unit 22. The storage unit 23 stores the probability distribution to be used to determine the policy. The calculation unit 22 updates the probability distribution stored in the storage unit 23 based on the loss inputted from the input unit 21. Although the details will be described later, the calculation unit 22 updates the probability distribution using the weighted sum of the probability distributions updated in the past as a constraint.

Also, the calculation unit 22 determines the next policy using the updated probability distribution, and outputs the next policy to the output unit 24. The output unit 24 outputs the policy determined by the calculation unit 22. When the outputted policy is executed, the resulting loss is inputted to the input unit 21. Thus, each time the policy is executed, the loss (reward) is fed back to the input unit 21, and the probability distribution stored in the storage unit 23 is updated. This allows the optimization device 100 to determine the next policy using the probability distribution adapted to the actual environment. In the above-described configuration, the input unit 21 is an example of an acquisition means, and the calculation unit 22 is an example of an update means and a determination means.

[Optimization Processing]

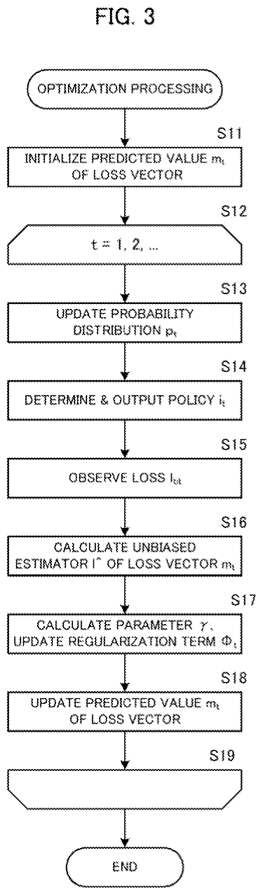

FIG. 3 is a flowchart of optimization processing according to the first example embodiment. This processing can be realized by the processor 12 shown in FIG. 1, which executes a program prepared in advance and operates as the elements shown in FIG. 2. As a premise, it is assumed that the number K of the plurality of selectable policies has been determined.

First, the predicted value mₜ of the loss vector is initialized (step S11). Specifically, “0” is set to the predicted value mi of the loss vector. Then, the loop processing including the following step S12˜S19 is repeated for the time step t=1,2, . . . .

First, the calculation unit 22 calculates the probability distribution pₜ by the following numerical formula (3) (step S13).

$${p}_{t} = {arg min}_{p ∈ {Δ}^{κ}} \{ {( {\sum }_{j = 1}^{t - 1} {\hat{ℓ}}_{j} + {m}_{t} )}^{⊤} p + {Φ}_{t} ( p ) \} \qquad ( 3 )$$

In the numerical formula (3), “l\hat{ }ⱼ” indicates the unbiased estimator of the loss vector, and “mₜ” indicates the predicted value of the loss vector. The first term in the curly brackets { } in the numerical formula (3) indicates the sum of the accumulated unbiased estimators of the loss vector and the predicted value of the loss vector until then (until one time step before). On the other hand, the second term “Φₜ(p)” in the curly brackets { } in the numerical formula (3) is a regularization term. The regularization term “Φₜ(p)” is expressed by the following numerical formula (4):

$${Φ}_{t} ( p ) = - {\sum }_{i = 1}^{K} {γ}_{ti} log {p}_{i} \qquad ( 4 )$$

In the numerical formula (4), γₜᵢ is a parameter that defines the strength of regularization by the regularization term Φₜ(p), which will be hereafter referred to as “the weight parameter”.

Next, the calculation unit 22 determines the policy iₜ based on the calculated probability distribution pₜ, and the output unit 24 outputs the determined policy iₜ (step S14). Next, the input unit 21 observes the loss lₜᵢₜ obtained by executing the policy iₜ outputted in step S14 (step S15). Next, the calculation unit 22 calculates the unbiased estimator of the loss vector using the obtained loss lₜᵢₜ by the following numerical formula (5) (step S16).

$${\hat{ℓ}}_{t} = {m}_{t} + \frac{{ℓ}_{{ti}_{t}} - {m}_{{ti}_{t}}}{{p}_{{ti}_{i}}} {χ}_{{i}_{t}} \qquad ( 5 )$$

In the numerical formula (5), “×ᵢₜ” is an indicator vector.

Next, the calculation unit 22 calculates the weight parameter γₜᵢ using the following numerical formula (6), and updates the regularization term Φₜ(p) using the numerical formula (4) (step S17).

$${γ}_{ti} = \sqrt{4 + \frac{1}{log ( Kt )} {\sum }_{j = 1}^{t - 1} {α}_{ji}} \qquad ( 6 )$$

In the numerical formula (6), “αⱼᵢ” is given by the numerical formula (7) below, which indicates the degree of outlier of the prediction loss.

αⱼᵢ:=2( [symbol] −mₜᵢ_{ₜ})²(1{iₜ=i}·(1−pₜᵢ)²+1{iₜ≠i}·pₜᵢ²) (7)

Therefore, when the degree of outlier αⱼᵢ of the prediction loss is increased, the calculation unit 22 gradually increases the weight parameter γₜᵢ indicating the strength of the regularization based on the numerical formula (6). Thus, the calculation unit 22 adjusts the weight parameter γₜᵢ that determines the strength of the regularization based on the degree of outlier of the loss prediction. Then, the calculation unit 22 performs different weighting using the weight parameter γₜᵢ for each past probability distribution pᵢ by the numerical formula (4) and updates the regularization term Φₜ(p). Thus, the probability distribution pₜ shown in the numerical formula (3) is updated by using the weighted sum of the past probability distributions as a constraint.

Next, the calculation unit 22 updates the predicted value mₜ of the loss vector using the following numerical formula (8) (step S18).

$${m}_{t + 1 , i} = \{ \begin{matrix}( 1 - λ ) {m}_{ti} + {λℓ}_{ti} & i = {i}_{t} \\ {m}_{ti} & i \neq {i}_{t}\end{matrix} \qquad ( 8 )$$

In the numerical formula (8), the loss lₜᵢ obtained as a result of the execution of the policy i selected in step S14 is reflected in the predicted value m_{t+1,i} of the loss vector for the next time step t+1 at a ratio of λ, and the predicted value mₜᵢ of the loss vector for the previous time step t is maintained for the policy that was not selected. The value of λ is set to, for example, λ=¼. The processing of the above steps S12˜S19 is repeatedly executed for the respective time steps t=1,2, . . . .

Thus, in the optimization processing of the first example embodiment, in the step S17, first, the weight parameter γₜᵢ indicating the strength of the regularization is calculated using the numerical formula (6) based on the accumulation of the degree of outlier of the loss prediction a in the past time steps, and then the regularization term Φₜ(p) is updated based on the weight parameter γₜᵢ by the numerical formula (4). Hence, the regularization term Φₜ(p) is updated by using the weighted sum of the past probability distributions as a constraint, and the strength of the regularization in the probability distribution pₜ shown in the numerical formula (3) is appropriately updated.

Also, in step S18, as shown in the numerical formula (8), the predicted value mₜ of the loss vector is updated by taking into account the loss obtained by executing the selected policy. Specifically, by reflecting the loss lₜᵢₜ obtained by the selected policy by the factor λ to generate the predicted value mₜ₊₁ of the loss vector of for the next time step. As a result, the predicted value mₜ of the loss vector is appropriately updated according to the result of executing the policy.

As described above, in the optimization processing of the first example embodiment, it is not necessary to select the algorithm in advance based on the target environment, and it is possible to determine the optimum policy by adaptively updating the probability distribution of the policy in accordance with the actual environment.

### Second Example Embodiment

[Premise Explanation]

The second example embodiment relates to a linear bandit problem. In the linear bandit problem, a set A of policies is given as a subset of a linear space R^{d}. At every time step t, the player selects the policy aₜ∈A and observes the loss lₜ^{T}aₜ. The loss vector lₜ∈R^{d} can be selected adversarially by circumstances. Suppose that the loss lₜ^{T}a∈R[0,1] is satisfied for all the policies. Regret is defined by numerical formula (9) below. Note that a* is the best policy.

$${R}_{T} = {\sum }_{t = 1}^{T} {ℓ}_{t}^{⊤} {a}_{t} = {min}_{{a}^{*} ∈ 𝒜} {\sum }_{t = 1}^{T} {ℓ}_{t}^{⊤} {a}^{*} \qquad ( 9 )$$

The framework of the linear bandit problem includes the multi-armed bandit problem as a special case. When the policy set is a normal basis {e₁, e₂, . . . , e_{d}}⊆R^{d} in d-dimensional real space, the linear bandit problem is equivalent to the multi-armed bandit problem with d arms of the loss lₜ^{T}eᵢ=lₜᵢ.

Therefore, even in the linear bandit problem, in order to achieve the optimum performance, it is necessary to select an appropriate algorithm according to the real-world environment. However, in reality, it is difficult to select an appropriate algorithm by knowing in advance the structure of the environment (stationary/non-stationary, magnitude of variation). In the second example embodiment, for the linear bandit problem, the need of selecting an algorithm depending on the structure of the environment is eliminated, and a single algorithm is used to obtain the same result as the case where an appropriate algorithm is selected from among a plurality of algorithms.

[Hardware Configuration]

The hardware configuration of the optimization device according to the second example embodiment is similar to the optimization device 100 of the first example embodiment shown in FIG. 1.

[Functional Configuration]

The functional configuration of the optimization device according to the second example embodiment is similar to the optimization device 100 of the first example embodiment shown in FIG. 2.

[Optimization Processing]

It is supposed that the predicted value mₜ∈R^{d} of the loss vector is obtained for the loss lₜ. In this setting, the player is given the predicted value mₜ of the loss vector by the time of selecting the policy aₜ. It is supposed that <mₜ, a>∈[1,−1] is satisfied for all the policies a. The following multiplicative weight updating is executed for the convex hull A′ in the policy set A.

$${w}_{t} ( x ) = exp ( - {η}_{t} 〈 {\sum }_{j = 1}^{t - 1} {\hat{ℓ}}_{j} + {m}_{t} , x 〉 ) \qquad ( 10 )$$

Here, ηⱼ is a parameter indicating a value greater than 0 and is a learning rate. Each loss l\hat{ }ⱼ is an unbiased estimator of lⱼ described below.

The probability distribution pₜ of the policy is given by the following numerical formula.

$${p}_{t} ( x ) = \frac{{w}_{t} ( x )}{{\int }_{y ∈ {𝒜}^{′}} {w}_{t} ( y ) d y} ( x ∈ {𝒜}^{′} ) \qquad ( 11 )$$

First, the truncated distribution p^{˜}ₜ (x) of the probability distribution pₜ is defined as follows. Here, βₜ is a parameter that indicates a value greater than 1.

$${\tilde{p}}_{t} ( x ) = \frac{{p}_{t} ( x ) 1 \{ {‖ x ‖}_{{S ( {p}_{t} )}^{- 1}}^{2} \leq d {β}_{t}^{2} \}}{{Pr}_{y ∼ {p}_{i}} ( x ) [ {‖ y ‖}_{{S ( {p}_{t} )}^{- 1}}^{2} \leq d {β}_{t}^{2} ]} ∝ {p}_{t} ( x ) 1 \{ {‖ x ‖}_{{S ( {p}_{t} )}^{- 1}}^{2} \leq d {β}_{t}^{2} \} \qquad ( 12 )$$

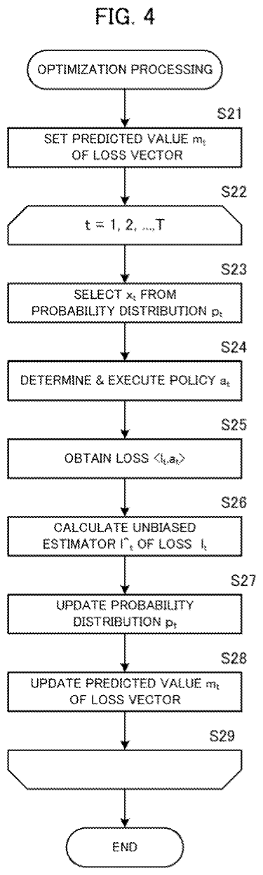

FIG. 4 is a flowchart of optimization processing according to the second example embodiment. This processing is realized by the processor 12 shown in FIG. 1, which executes a program prepared in advance and operates as the elements shown in FIG. 2.

First, the calculation unit 22 arbitrarily sets the predictive value mₜ∈L of the loss vector (step S21). The set L is defined as follows:

[symbol]

={l∈ [symbol] |−1≤ [symbol] [symbol] a [symbol] ≤1 for all a∈ [symbol] } (13)

Then, for the time steps t=1, 2, . . . ,T, the loop processing of the following steps S22˜S29 is repeated.

First, the calculation unit 22 repeatedly selects xₜ from the probability distribution pₜ(x) defined by the numerical formula (11) until the norm of xₜ becomes equal to or smaller than d βₜ², i.e., until the numerical formula (14) is satisfied (step S23).

∥xₜ∥_{S(p}_{ₜ}₎_{^{−1}}²≤dβₜ² (14)

Next, the calculation unit 22 selects the policy aₜ so that the expected value E[aₜ]=xₜ and executes the policy aₜ (step S24). Then, the calculation unit 22 acquires the loss<lₜ, aₜ> by executing the policy a t (step S25). Next, the calculation unit 22 calculates the unbiased estimator l\hat{ }ₜ of the loss lₜ by the following numerical formula (15) (step S26).

[symbol]

ₜ=mₜ+ [symbol] [symbol] ₜ,aₜ−mₜ [symbol] ·S(\tilde{p}ₜ)⁻¹xₜ (15)

Next, the calculation unit 22 updates the probability distribution P t using the numerical formula (11) (step S27). Next, the calculation unit 22 updates the predicted value mₜ of the loss vector using the following numerical formula (16) (step S28).

$${m}_{t + 1} ∈ {arg min}_{m ∈ ℒ} \{ λ 〈 {m}_{t} - {ℓ}_{t} , {a}_{t} 〉 〈 {a}_{t} , m 〉 + D ( m \vert \vert {m}_{t} ) \} \qquad ( 16 )$$

The numerical formula (16) uses the coefficients λ and D to determine the magnitude of updating the predicted mₜ of the loss vector. In other words, the predicted value of the loss vector is modified in the direction of decreasing the prediction error with a step size of about the coefficient λ. Specifically, “λ<(mₜ−lₜ, aₜ>)” in the numerical formula (16) adjusts the predicted value mₜ of the loss vector in the opposite direction to the deviation between the predicted value mₜ of the loss vector and the loss lₜ. Also, “D(m∥mₜ)” corresponds to the regularization term for updating the predicted mₜ of the loss vector. Namely, similarly to the numerical formula (3) of the first example embodiment, the numerical formula (16) adaptively adjusts the strength of regularization in the predictive value mₜ of the loss vector in accordance with the loss caused by the execution of the selected policy. Then, the probability distribution P t is updated by the numerical formulas (10) and (11) using the predicted value mₜ of the adjusted loss vector. As a result, even in the optimization processing of the second example embodiment, and it becomes possible to determine the optimum policy by adaptively updating the probability distribution in accordance with the actual environment, without the need of selecting the algorithm in advance based on the target environment.

### Third Example Embodiment

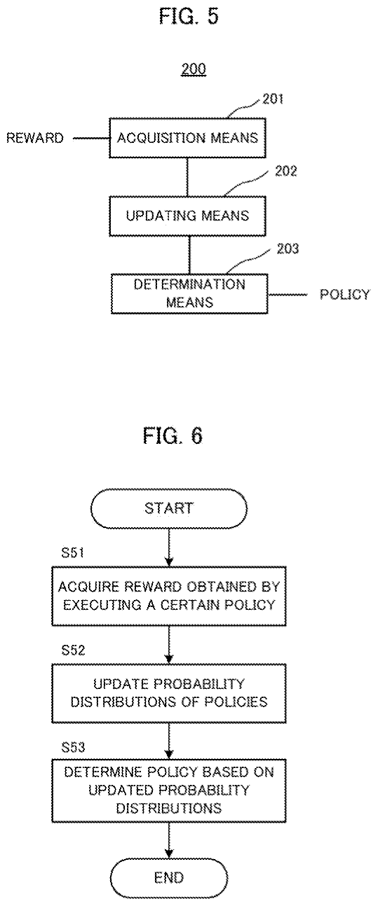

Next, a third example embodiment of the present disclosure will be described. FIG. 5 is a block diagram illustrating a functional configuration of an optimization device 200 according to the third example embodiment. The optimization device 200 includes an acquisition means 201, an updating means 202, and a determination means 203. The acquisition means acquires a reward obtained by executing a certain policy. The updating means updates a probability distribution of the policy based on the obtained reward. Here, the updating means uses a weighted sum of the probability distributions updated in a past as a constraint. The determination means determines the policy to be executed, based on the updated probability distribution.

FIG. 6 is a flowchart illustrating prediction processing executed by the optimization device according to the third example embodiment. In the optimization device 200, the acquisition means acquires a reward obtained by executing a certain policy (step S51). The updating means updates a probability distribution of the policy based on the obtained reward (step S52). Here, the updating means uses a weighted sum of the probability distributions updated in a past as a constraint. The determination means determines the policy to be executed, based on the updated probability distribution (step S53).

According to the third example embodiment, by updating the probability distribution using the weighted sum of the probability distributions updated in the past as a constraint, it becomes possible to determine the optimum policy by adaptively updating the probability distribution of the policy according to the actual environment, without the need of selecting the algorithm in advance based on the target environment.

### EXAMPLES

Next, examples of the optimization processing of the present disclosure will be described.

### Basic Example

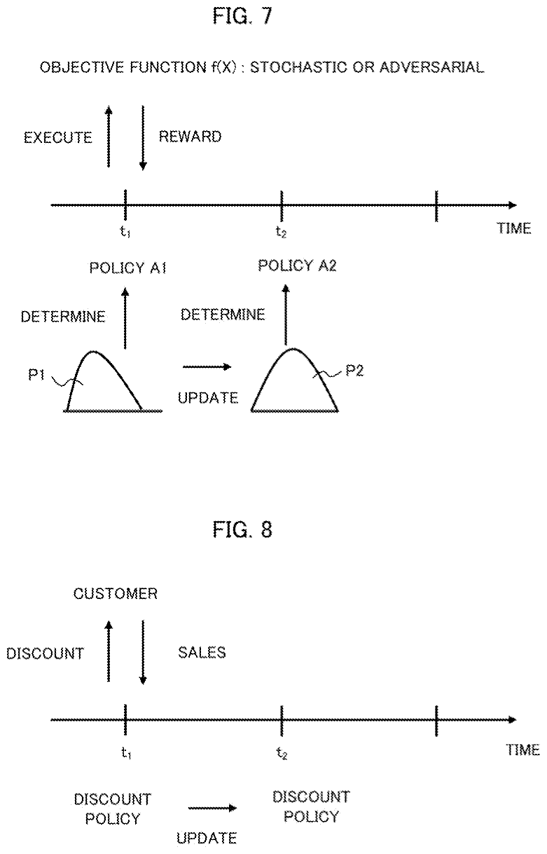

FIG. 7 schematically illustrates a basic example of the optimization processing of the present disclosure. The objective function f(x) corresponding to the environment in which the policy is selected by decision-making may be stochastic or adversarial, as described above. When a policy A1 is selected and executed based on the probability distribution P1 of the policy at the time t₁, a reward (loss) corresponding to the objective function f(x) is obtained. Using this reward, the probability distribution is updated from P1 to P2, and the policy A2 is selected based on the updated probability distribution P2 at the time t₂. In this case, by applying the optimization method of the example embodiments, it is possible to determine an appropriate policy according to the environment indicated by the objective function f (x).

### Example 1

FIG. 8 shows an example of applying the optimization method of the example embodiments to a field of retail. Specifically, the policy is to discount the price of beer of each company in a certain store. For example, in the execution policy X=[0, 2, 1, . . . ], it is assumed that the first element indicates setting the beer price of Company A to the regular price, the second element indicates increasing the beer price of Company B by 10% from the regular price, and the third element indicates discounting the beer price of Company C by 10% from the regular price.

For the objective function, the input is the execution policy X, and the output is the result of selling by applying the execution policy X to the price of beer of each company. In this case, by applying the optimization method of the example embodiments, it is possible to derive the optimum pricing of the beer price of each company in the above store.

### Example 2

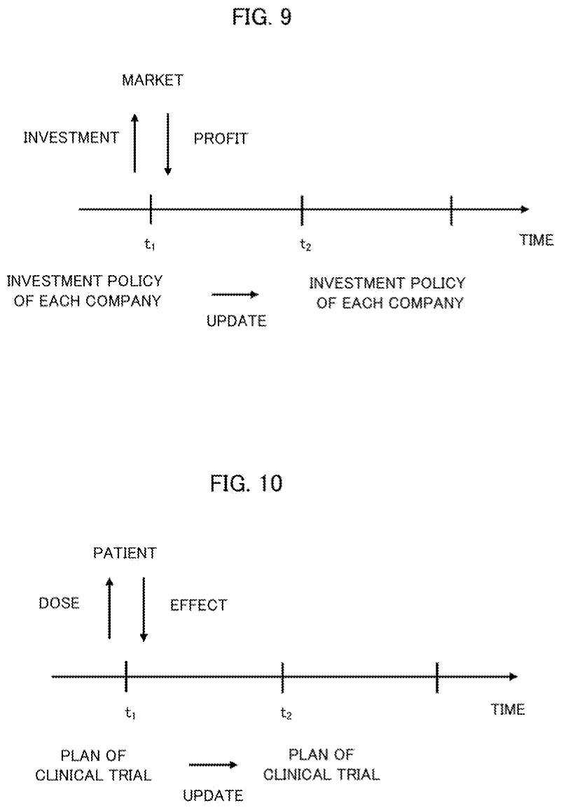

FIG. 9 shows an example of applying the optimization method of the example embodiments to a field of investment. Specifically, a description will be given of the case where the optimization method is applied to investment behavior of investors. In this case, the execution policy is to invest (buy, increase), sell, or hold multiple financial products (stock name, etc.) that the investor holds or intends to hold. For example, in the execution policy X=[1, 0, 2, . . . ], it is assumed that the first element indicates an additional investment in the stock of Company A, the second element indicates holding (neither buy nor sell) the credit of Company B, and the third element indicates selling the stock of Company C. For the objective function, the input is the execution policy X, and the output is the result of applying the execution policy X to the investment action for the financial product of each company.

In this case, by applying the optimization method of the example embodiments, the optimum investment behavior for the stocks of the above investors can be derived.

### Example 3

FIG. 10 shows an example of applying the optimization method of the example embodiments to a medical field. Specifically, the description will be given of the case where the optimization method is applied to the dosing behavior for the clinical trial of a certain drug in a pharmaceutical company. In this case, the execution policy X is the quantity of dosing or avoiding the dosing. For example, in the execution policy X=[1, 0, 2, . . . ], it is assumed that the first element indicates dosing of the dosage amount 1 for the subject A, the second element indicates avoiding dosing for the subject B, and the third element indicates dosing of the dosage amount 2 for the subject C. For the objective function, the input is the execution policy X, and the output is the result of applying the execution policy X to the dosing behavior for each subject.

In this case, by applying the optimization method of the example embodiments, the optimal dosing behavior for each subject in the clinical trial of the above-mentioned pharmaceutical company can be derived.

### Example 4

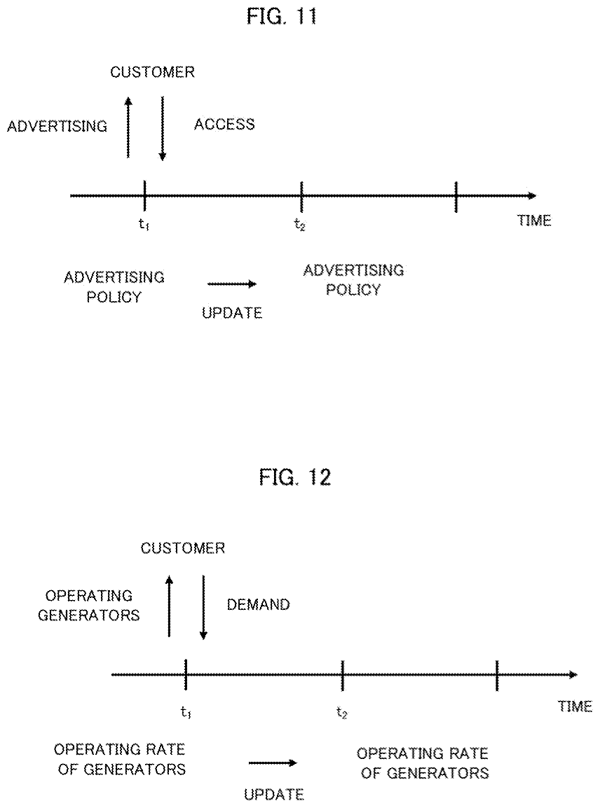

FIG. 11 shows an example of applying the optimization method of the example embodiments to marketing. Specifically, the description will be given of the case where the optimization method is applied to advertising behavior (marketing measures) in an operating company of a certain electronic commerce site. In this case, the execution policy is the advertising (online (banner) advertising, e-mail advertising, direct mails, e-mail transmission of discount coupons, etc.) of the products or services to be sold by the management company for a plurality of customers. For example, in the execution policy X=[1, 0, 2, . . . ], the first element indicates the banner advertisement for the customer A, the second element indicates not making the advertisement for the customer B, and the third element indicates the e-mail transmission of the discount coupons to the customer C. For the objective function, the input is the execution policy X, and the output is the result of applying the execution policy X to the advertising behavior for each customer. Here, as the execution result may be whether or not the banner advertisement was clicked, the purchase amount, the purchase probability or the expected value of the purchase amount.

In this case, by applying the optimization method of the example embodiments, the optimum advertising behavior for each customer in the above operating company can be derived.

### Example 5

FIG. 12 shows an example of applying the optimization method of the example embodiments to the estimation of power demand. Specifically, the operation rate of each generator at a certain power generation facility is the execution policy. For example, in the execution policy X=[1, 0, 2, . . . ], each element indicates the operation rate of the individual generators. For the objective function, the input is the execution policy X, and the output is the power demand based on the execution policy X.

In this case, by applying the optimization method of the example embodiments, the optimum operation rate for each generator in the power generation facility can be derived.

### Example 6

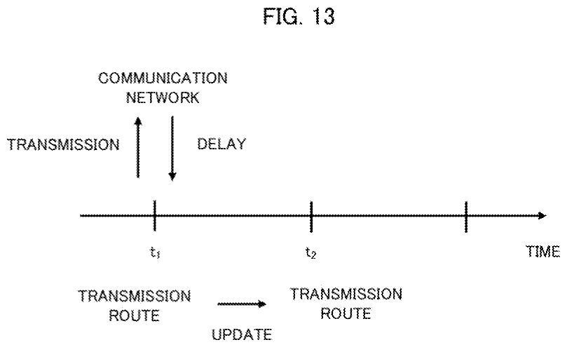

FIG. 13 shows an example of applying the optimization method of the example embodiments to a field of communication. Specifically, the description will be given of the case of applying the optimization method to the minimization of the delay in the communication through the communication network. In this case, the execution policy is to select one transmission route from multiple transmission routes. For the objective function, the input is the execution policy X, and the output is the delay amount generated as a result of the communication in each transmission route.

In this case, by applying the optimization method of the example embodiments, it is possible to minimize the communication delay in the communication network.

A part or all of the example embodiments described above may also be described as the following supplementary notes, but not limited thereto.

(Supplementary Note 1)

An optimization device comprising:
an acquisition means configured to acquire a reward obtained by executing a certain policy;
an updating means configured to update a probability distribution of the policy based on the obtained reward; and
a determination means configured to determine the policy to be executed, based on the updated probability distribution,
wherein the updating means uses a weighted sum of the probability distributions updated in a past as a constraint.

(Supplementary Note 2)

The optimization device according to Supplementary note 1, wherein the updating means updates the probability distribution using an updating formula including a regularization term indicating the weighted sum of the probability distributions.

(Supplementary Note 3)

The optimization device according to Supplementary note 2, wherein the regularization term is calculated by performing different weighting for each past probability distribution using a weight parameter indicating strength of regularization.

(Supplementary Note 4)

The optimization device according to Supplementary note 3, wherein the weight parameter is calculated based on an outlier of a predicted value of a loss.

(Supplementary Note 5)

The optimization device according to any one of Supplementary notes 2 to 4, wherein the updating means updates the probability distribution on a basis of the probability distributions based on a sum of an accumulation of estimators of the loss in past time steps and a predicted value of the loss in a current time step, and the regularization term.

(Supplementary Note 6)

The optimization device according to Supplementary note 4 or 5, wherein the predicted value of the loss is calculated by reflecting the obtained reward in the previous time step with a predetermined coefficient.

(Supplementary Note 7)

An optimization method comprising:
acquiring a reward obtained by executing a certain policy;
updating a probability distribution of the policy based on the obtained reward; and
determining the policy to be executed, based on the updated probability distribution,
wherein the probability distribution is updated by using a weighted sum of the probability distributions updated in a past as a constraint.

(Supplementary Note 8)

A recording medium recording a program, the program causing a computer to execute:
acquiring a reward obtained by executing a certain policy;
updating a probability distribution of the policy based on the obtained reward; and
determining the policy to be executed, based on the updated probability distribution,
wherein the probability distribution is updated by using a weighted sum of the probability distributions updated in a past as a constraint.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

12 Processor
21 Input unit
22 Calculation unit
23 Storage unit
24 Output unit
100 Optimization device

What is claimed is:

1. An optimization device comprising:
a memory configured to store instructions; and
one or more processors configured to execute the instructions to:
acquire a reward obtained by executing a certain policy;
update a probability distribution of the policy based on the obtained reward; and
determine the policy to be executed, based on the updated probability distribution,
wherein the probability distribution is updated by using a weighted sum of the probability distributions updated in a past as a constraint.

2. The optimization device according to claim 1, wherein the one or more processors update the probability distribution using an updating formula including a regularization term indicating the weighted sum of the probability distributions.

3. The optimization device according to claim 2, wherein the regularization term is calculated by performing different weighting for each past probability distribution using a weight parameter indicating strength of regularization.

4. The optimization device according to claim 3, wherein the weight parameter is calculated based on an outlier of a predicted value of a loss.

5. The optimization device according to claim 2, wherein the one or more processors the probability distribution on a basis of the probability distributions based on a sum of an accumulation of estimators of the loss in past time steps and a predicted value of the loss in a current time step, and the regularization term.

6. The optimization device according to claim 4, wherein the predicted value of the loss is calculated by reflecting the obtained reward in the previous time step with a predetermined coefficient.

7. An optimization method comprising:
acquiring a reward obtained by executing a certain policy;
updating a probability distribution of the policy based on the obtained reward; and
determining the policy to be executed, based on the updated probability distribution,
wherein the probability distribution is updated by using a weighted sum of the probability distributions updated in a past as a constraint.

8. A non-transitory computer-readable recording medium recording a program, the program causing a computer to execute:
acquiring a reward obtained by executing a certain policy;
updating a probability distribution of the policy based on the obtained reward; and
determining the policy to be executed, based on the updated probability distribution,
wherein the probability distribution is updated by using a weighted sum of the probability distributions updated in a past as a constraint.
